(19) United States
(12) Patent Application Publication
(10) Pub. No.: US 2006/0135115 A1
(43) Pub. Date: Jun. 22, 2006

(54) Systems and methods for public safety notification

(76) Inventor: James Bell, Lebanon, NJ (US)

Correspondence Address: MORGAN LEWIS & BOCKIUS LLP, 1111 PENNSYLVANIA AVENUE NW, WASHINGTON, DC, 20004, US

(21) Appl. No.: 11/187,766

(22) Filed: Jul. 22, 2005

Related U.S. Application Data
(60) Provisional application No. 60/590,800, filed on Jul. 22, 2004.

(51) Int. Cl. H04M 11/04

(52) U.S. Cl. 455/404.1

(57) ABSTRACT

A preferred embodiment of the present invention comprises a system for emergency notification, comprising: one or more radio broadcasting stations operable to transmit signals in at least one of: RDS and RBDS format; and one or more receivers operable to receive signals in at least one of: RDS and RBDS format. Preferably, the radio broadcasting stations are in communication with at least one on-site commander via a back-channel data link, and the receiver is further operable to receive encoded paging information. In various embodiments: (a) the encoded paging information comprises RDS paging activation codes; and (b) the on-site commander is equipped with a computer operable to record status and arrival of fire companies.

### CROSS REFERENCE TO RELATED APPLICATIONS

This application claims the benefit of U.S. Provisional Application No. 60/590,800, filed Jul. 22, 2004. The entire contents of that provisional application are incorporated herein by reference.

### BACKGROUND

Fire fighting is arguably the most dangerous profession in the world. No example is more vivid than that of the lives lost at the World Trade Center on Sep. 11, 2001. Three hundred forty three New York City firefighters were among 403 public safety workers who were killed when the towers collapsed.

Much of the blame for this extraordinary loss of life has been targeted on poor communications—specifically on the inability to order an evacuation utilizing the fire department's two way radio system.

Notifying firefighters of the need to evacuate a building is a critical but often poorly executed procedure in the fire service. This notification is usually made by transmissions over the department's two way radio system and by sounding air horns.

The WTC disaster vividly demonstrated how ineffective the concept of the air horn method is in the urban environment. The use of two way radios in urban, suburban, and even rural venues can also be problematic, especially in the chaotic and adrenaline-charged atmosphere of a fire scene. The evacuation order has difficulty obtaining the priority it requires and competes with other radio traffic, risking being lost in the background radio “noise.”

The problems with utilizing public safety two way radio systems have been cited and analyzed in numerous reports critiquing the response and performance of public safety services at the World Trade Center. While they all cite significant problems, there is little offered in these reports to provide an effective and reliable method of notifying firefighters to evacuate a building when those in authority deem it necessary.

However, methods and systems are described herein that can be developed utilizing existing resources and can dramatically improve the effectiveness of evacuation notification.

The two way radio systems utilized by public safety forces—be they police, fire, EMS, or emergency management—are usually adequate for dispatch and status reporting. While in reality most organizations complain about coverage and reliability even in day-to-day use, these deficiencies are generally system related design issues. The equipment and systems are for the most part reliable but are plagued by systemic problems. Among these are: (a) Insufficient base station radio frequency (rf) power to ensure coverage into buildings; (b) inadequate audio power (volume) from the portable radios (walkie-talkie) to ensure that messages can be heard in a noise filled environment; and (c) insufficient battery life with portable radios to ensure communications for extended periods with a reserve for any evacuation messages. The transmissions from vehicles are at lower power and with a more inefficient antenna system than the base station, making them more difficult to be heard in a steel framed building.

Thus, the traditional two-way radio system is not the ideal tool to initiate the most critical of all fire department procedures: an evacuation.

The only product identified whose purpose is evacuation notification is manufactured by Grace Industries and marketed as the Personal Alert Safety System. Although this product is designed for evacuation notification, its low rf power output and limited-scope interface make it of little use to major fire departments or those serving larger commercial buildings.

Yet there is a radio service that does penetrate buildings of all types on a day-to-day basis. FM entertainment radio is broadcast at high power from sites with sophisticated antenna structures and received by millions of listeners everyday, many in office buildings. Driven by the need to maintain operations for revenue purposes, these stations often have back up transmitters, generators, and sometimes back up locations.

What more and more stations also have is the ability to transmit “information” along with their entertainment content, utilizing the RDS (Radio Data System) format (RDS is the international definition; in the United States, the definition is RBDS, for Radio Broadcast Data System.)

RDS is an established, standards-based technology that permits FM radio stations to transmit data comprising text based information in conjunction with the entertainment portion of the broadcast. Compatible receivers with display capabilities can provide text station identification, artist identity, and road and traffic conditions.

A component of the RDS technical standard is “paging” which permits operation in a manner similar to the “beeper” paging so popular in the pre-cell phone era. This component is powerful enough to penetrate buildings.

### SUMMARY

A preferred embodiment of the present invention comprises a system for emergency notification that combines the RDS ability to transmit powerful signals with a paging information component. The system incorporates the RDS capability of selected FM radio stations, as well as a specialized addressable receiver with appropriate audio and visual signaling capabilities and prolonged battery life. These elements are combined with a reliable and survivable communications channel to permit activation of the evacuation signal and a software based tool (Command Board) which enables commanders and dispatchers to accurately record the arrival and status of fire companies to permit notification to all involved personnel if an evacuation order is issued.

It is important is understand the expansion potential of the market and scaling capabilities of the design concept. A preferred embodiment comprises a fee for service product. While this product can benefit all departments, for paid departments it represents a relatively small cost—especially when measured against the benefit.

Support for the scaling capabilities of the product and the relative ease of customer expansion lies in the fact that radio stations typically cover an extended geographic area. By way of example, a New York station can easily serve an area of at least twenty miles in diameter, allowing coverage of municipalities in Long Island, N.J., and Westchester County, N.Y. This expanded market can be served with little or no cost infrastructure cost increase.

While the preferred application of this warning system is to provide reliable evacuation notification for firefighters in more urban environments, there are other applications. The forest fire services could benefit from a wide area alerting and notification capability and this concept could support that need. This operational model, with an appropriate receiver, could also be utilized for public warning in areas subject to tornados and flooding or for evacuation warnings near nuclear power plants. The system could be utilized for emergency and critical need personnel mobilization. Beyond the domestic market, the evacuation notification and other emergency functions could be marketed globally. RDS currently has a significant deployment in Europe.

While the New York example of product suitability is most dramatic, this product can be replicated nationally in all markets utilizing the same concept and techniques. The development costs are basically a one time expense and the greater the deployment the greater the revenue and profit.

Because of the dependence on utilizing one or more FM broadcast stations and the assumption that there will be associated costs, this product preferably will be offered as a subscription service rather than a purchasable product. It is anticipated that the fee for a radio station will be a percentage of the revenues generated in its coverage area. This involves enlisting stations as partners; the more subscribers, the greater the stations' revenue. The service may be offered on a cost per receiver basis contracted on a yearly or multiyear basis. As an incentive, the receiver can be provided at no additional cost with the subscription.

The communications channel for signal activation and the software Command Board “status” tool can be developed and implemented utilizing commercially available products and services. But there is no commercially available receiver that can perform the function of the firefighter's evacuation receiver of this invention, sustain the environment, and respond to the RDS signaling.

A preferred embodiment of the present invention comprises a system for emergency notification, comprising: one or more radio broadcasting stations operable to transmit signals in at least one of: RDS and RBDS format; and one or more receivers operable to receive signals in at least one of: RDS and RBDS format. Preferably, the radio broadcasting stations are in communication with at least one on-site commander via a back-channel data link, and the receiver is further operable to receive encoded paging information. In various embodiments: (a) the encoded paging information comprises RDS paging activation codes; and (b) the on-site commander is equipped with a computer operable to record status and arrival of fire companies.

### BRIEF DESCRIPTION OF THE DRAWINGS

FIG. 1 depicts a preferred system configuration.

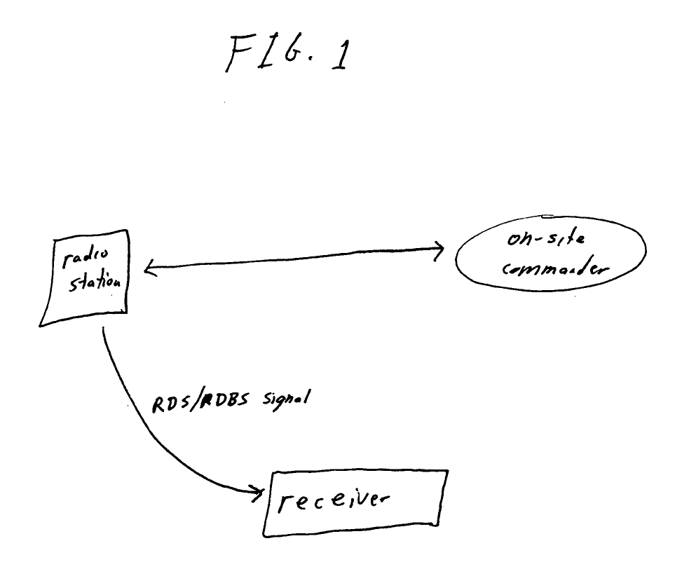

### DETAILED DESCRIPTION OF PREFERRED EMBODIMENTS

In a preferred embodiment, the invention comprises a public safety evacuation receiver that comprises a self contained Radio Broadcast Data System (RBDS) receiver with addressable paging capabilities and alerting functionality. The receiver operates in conjunction with RBDS broadcasts from selected FM stations equipped with paging encoder capabilities. The alert activation preferably is initiated by a code transmitted by an on-site commander via a back-channel data link.

The entire receiver (including battery) preferably is housed in a watertight heavy duty plastic case. The only penetrations of the case preferably are for the antenna, a visual alert indicator, and a battery condition indicator. The preferred approximate size is 2.25″×4.0″×1.5.″ The case preferably has an integral locking clip that can rotate to assure proper positioning.

The receiver circuitry preferably comprises a Global Navigation Systems Embedded FM Tuner Module. This low power RDS/RBDS receiver preferably utilizes phase locked loop tuning, permitting scanning for appropriate FM stations. Sensitivity preferably is increased by utilizing an external flexible antenna.

RDS paging activation codes preferably are read and decoded by a Phillips PCD 5008 chip. This enables driver circuits which activate a solid state audio transducer capable of producing a sound level of 95 dBA. The driver may produce a cycling of the transducer output so that the audio signal is more noticeable.

The decoder chip preferably also activates a driver that powers a white high-output flashing LED indicator mounted in a clear Fresnel lens on the top of the receiver. The circuit will cause the LED to flash for visual notification.

The receiver preferably is powered by rechargeable nickel hydride batteries. The charging circuit preferably utilizes low voltage inductive coupling with a 110 volt charger. This reduces power contacts and corrosion problems.

A power monitor and management circuit preferably is incorporated into the receiver. By utilizing a power monitor circuit, a low output red LED preferably mounted flush with the case will be illuminated at all times when the battery meets the minimum power threshold for satisfactory performance. Minimum battery life in stand by monitoring mode with two alert cycles of 10 minutes each preferably is 96 hours.

Programming the receiver paging code preferably is done by an inductively coupled tool utilizing a Windows-based PC as the input device. The receiver can be coded to any one of the unique codes defined by the United States RBDS Standard, Apr. 9, 1998 (approximately 40,000 codes per broadcast network are available).

Power on/off and resetting the alert signal preferably are accomplished by a coded proximity key that maintained by a supervisor.

I claim:

1. A system for emergency notification, comprising:
one or more radio broadcasting stations operable to transmit signals in at least one of: RDS and RBDS format; and
one or more receivers operable to receive signals in at least one of: RDS and RBDS format;
wherein said one or more radio broadcasting stations are in communication with at least one on-site commander via a back-channel data link, and
wherein said receiver is further operable to receive encoded paging information.

2. A system as in claim 1, wherein said encoded paging information comprises RDS paging activation codes.

3. A system as in claim 1, wherein said on-site commander is equipped with a computer operable to record status and arrival of fire companies.
